(19) United States
(12) Patent Application Publication
(10) Pub. No.: US 2026/0244772 A1
(43) Pub. Date: Aug. 20, 2026

(54) Data Transfer Approval Prior to a Secure Data Transfer

(71) Applicant: Apple Inc., Cupertino, CA (US)

(72) Inventors: Maria D. Escobar, San Francisco, CA (US); Kartik Subramanian, Sunnyvale, CA (US); Luke Butcher, Fremont, CA (US); Yousuf H. Vaid, Fremont, CA (US)

(73) Assignee: Apple Inc., Cupertino, CA (US)

(21) Appl. No.: 19/057,319

(22) Filed: Feb. 19, 2025

(51) Int. Cl. G06F 21/60; G06F 21/78

(52) U.S. Cl. CPC G06F 21/606; G06F 21/78

(57) ABSTRACT

Techniques for data transfer approval prior to a secure data transfer are described herein. A data requestor service can transmit, to a data storage service, a data transfer criteria request to transmit first data through a secure data transfer service from the data storage service to the data requestor service. The data transfer criteria request can indicate a first criteria regarding the first data for transmitting the first data. The data requestor service can receive, from the data storage service, a data transfer criteria response indicating that the first criteria regarding the first data is met. In response, the data requestor service can transmit a data request to transmit the first data from the data storage service to the data requestor service. The data requestor service can receive, from the secure data transfer service, a data response including the first data.

### BACKGROUND

Data may be requested by a data requestor from a data storage. The data may need to be transferred to the data requestor from the data storage via a secure data transfer service. Use of the secure data transfer service may use special resources.

### BRIEF DESCRIPTION OF THE DRAWINGS

FIG. 1 illustrates a block diagram for performing the techniques described herein, according to an embodiment of the present disclosure.

FIG. 2 illustrates a sequence diagram for illustrating the techniques described herein, according to an embodiment of the present disclosure.

FIGS. 3A-3B illustrate block diagrams for illustrating the techniques described herein, according to an embodiment of the present disclosure.

FIG. 4 illustrates a sequence diagram for illustrating the techniques described herein, according to an embodiment of the present disclosure.

FIGS. 5A-5B illustrate block diagrams for performing the techniques described herein, according to an embodiment of the present disclosure.

FIG. 6 illustrate a sequence diagram for describing the techniques described herein, according to an embodiment of the present disclosure.

FIGS. 7A-7C illustrate block diagrams for performing the techniques described herein, according to an embodiment of the present disclosure.

FIG. 8 illustrates a sequence diagram for performing the techniques described herein, according to an embodiment of the present disclosure.

FIG. 9 illustrates example user interfaces for performing the techniques described herein, according to an embodiment of the present disclosure.

FIG. 10 illustrates a flow diagram for performing the techniques described herein, according to an embodiment of the present disclosure.

FIG. 11 illustrates a flow diagram for performing the techniques described herein, according to an embodiment of the present disclosure.

FIG. 12 illustrates an example architecture or environment configured to implement the techniques described herein, according to an embodiment of the present disclosure.

### DETAILED DESCRIPTION

In the following description, various examples will be described. For purposes of explanation, specific configurations and details are set forth in order to provide a thorough understanding of the examples. However, it will also be apparent to one skilled in the art that the examples may be practiced without the specific details. Furthermore, well-known features may be omitted or simplified in order not to obscure the example being described.

Examples of the present disclosure are directed to, among other things, methods, systems, devices, and computer-readable media that provide techniques for determining that data meets criteria prior to transferring the data through a secure data transfer service from a data storage to a data requestor. A data requestor may request a data transfer from a data storage using a secure data transfer service. However, using the secure data transfer service can be costly in terms of various computing resources. The secure data transfer service may include additional safeguards to secure data transfers which may require additional processing (for example, for encryption) and/or additional infrastructure (for example, servers, fiber optics, copper, wireless transmitters, memory).

In some examples, a data request for first data may be sent from the data requestor to the data storage through the secure data transfer service. The data request can include a first criteria regarding the first data for transmitting the first data. The data storage can determine if the first criteria regarding the first data is met. If the data storage determines that the first criteria regarding the first data is met, then the data storage can transmit a data response with the first data to the data requestor via the secure data transfer service.

However, if the data storage determines that the first criteria regarding the first data is not met, the data response to the data request can indicate that the first criteria regarding the first data was not met. In this case, the first data is not transmitted to the data requestor via the secure data transfer service. When the secure data transfer service is used for a data request and a data response when the first data is not transmitted, the use of the secure data transfer service may be too costly in terms of computing resources. In such cases, it is preferable to determine that the first criteria regarding the first data is met prior to the data requestor sending a data request to the data storage via the secure data transfer service.

The techniques described herein enable the data requestor to send a data transfer criteria request (also referred to as a data transfer approval request) to the data storage without using the secure data transfer service. The data transfer criteria request can include a first criteria regarding the first data for transmitting the first data. The data storage can determine that the first criteria is met or not met. The data storage can then transmit a data transfer criteria response (also referred to as a data transfer approval response) to the data requestor with an indication that the first criteria is met or not met. If the first criteria is not met, the data requestor may determine to not send a data request for the first data to the data storage via the secure data transfer service. If the first criteria is met, the data requestor may determine to send a data request for the first data to the data storage via the secure data transfer service.

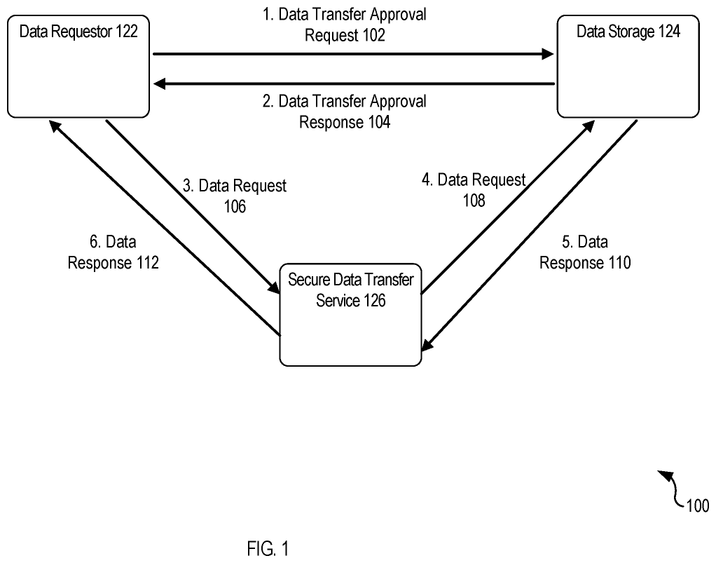

Turning now to the figures, FIG. 1 illustrates an example block diagram 100 with example systems and components for implementing the techniques described herein. A data requestor 122 can request first data from a data storage 124 to be transferred via a secure data transfer service 126. The data requestor 122 can request that the first data is transmitted from the data storage 124 via a secure data transfer service 126. The secure data transfer service 126 can include multiple security measures to secure a data transfer. These security measures can include encryption, the use of specific channels for the data transfer, and various other digital and real-world security measures.

Prior to sending a data request 106, the data requestor 122 can transmit a data transfer approval request 102 (also referred to as a data transfer criteria request) to the data storage 124. The data transfer approval request 102 can include a first criteria regarding the first data for transmitting the data. The data storage 124 can determine that the first data meets or does not meet the first criteria. The data storage 124 can transmit a data transfer approval response (also referred to as a data transfer criteria response) to the data requestor 122 with an indication whether the first data meets or does not meet the first criteria.

In response to receiving the indication that the first criteria regarding the first data is met, the data requestor 122 can send a data request 106 to the secure data transfer service 126 requesting that the secure data transfer service 126 transmit the first data from the data storage 124 to the data requestor 122. The secure data transfer service 126 can receive the data request 106 and transmit a data request 108 to the data storage 124. The data storage 124 may perform additional checks on the data request 108 to verify the data request 108. For example, the data request 108 can include the first criteria regarding the first data for transmitting the data. The data storage 124 can determine if the first criteria is met or not met. The data storage 124 can also determine that the data request 108 includes correct and/or verifiable information regarding the data requestor 122 and the secure data transfer service 126. In this way, the data storage 124 can verify that the data request 108 is a proper data request and not a data request from a bad actor. The data storage 124 can transmit a data response 110 to the secure data transfer service 126. The secure data transfer service 126 can receive the data response 110 and transmit the data response 112 to the data requestor 122. The data response 110 and the data response 112 can include the first data.

In some examples, the data requestor 122 can include one or more devices. For example, a first device of the data requestor 122 can transmit the data transfer approval request 102 and the data request 106, but a second device of the data requestor 122 can receive the data response 112.

In some examples, the data requestor 122 can include a client application on a device. For example, the client application can include an app on a user device such as a phone. The client application can be referred to as a data requestor client. In some examples, the data requestor 122 can include a data requestor service that is executed across one or more devices (for example, one or more servers). The one or more devices executing the service can be referred to as the data requestor server(s).

In some examples, the data requestor 122 can use an approval service to communicate with the data storage 124. For example, the data requestor 122 can transmit the data transfer criteria request to the approval service and the approval service can transmit the data transfer criteria request to the data storage 124. The data requestor 122 may not have sufficient information in order to transmit the data transfer criteria request to the data storage 124 for data security and/or data privacy reasons. In such examples, the data requestor 122 may send the data transfer criteria request to the approval service and include a data storage identifier. The approval service can determine the corresponding data storage based on the data storage identifier. In some examples, the approval service can include a client application on a device. For example, the client application may be an app on a user device such as a phone. This client application can be referred to as an approval client. In some examples, the approval service can include a service that is executed across one or more devices (for example, one or more servers). The one or more devices executing the approval service can be referred to as the approval server(s).

In some examples, the data requestor 122 can be a merchant. In some examples, the data storage 124 can be a payment service provider (PSP) such as a bank (or, alternatively, a bank affiliate) or a corporate entity. In some examples, the secure data transfer service 126 can be an acquirer processor, a payment facilitator, aggregator, or payment network. For example, the data requestor 122 can be requesting payment data from the data storage 124. A data requestor 122 may be processing a transaction from a customer. The customer provides payment information to the data requestor 122. For example, the customer provides a credit card or debit card associated with a particular data storage 124 (for example, a bank). In this example, the data requestor 122 determines a first criteria, namely whether the customer has sufficient funds at the data storage 124. In this example, the data requestor 122 transmits a data transfer approval request 102 to the data storage 124 to determine if the customer has sufficient funds. If the data storage 124 determines that the customer has sufficient funds (for example, the first criteria of the first data is met), the data storage 124 can transmit the data transfer approval response 104 to the data requestor 122 indicating that the customer has sufficient funds. In this example, the data requestor 122 can ensure that they only send a data request 106 via the secure data transfer service 126 when the data request 106 will be fulfilled by a data response 112 (for example, that the customer has sufficient funds). In this way, the data requestor 122 can avoid use of the secure data transfer service 126 (and the associated computing and other costs) if the customer does not have sufficient funds and the data request would be denied by the data storage 124.

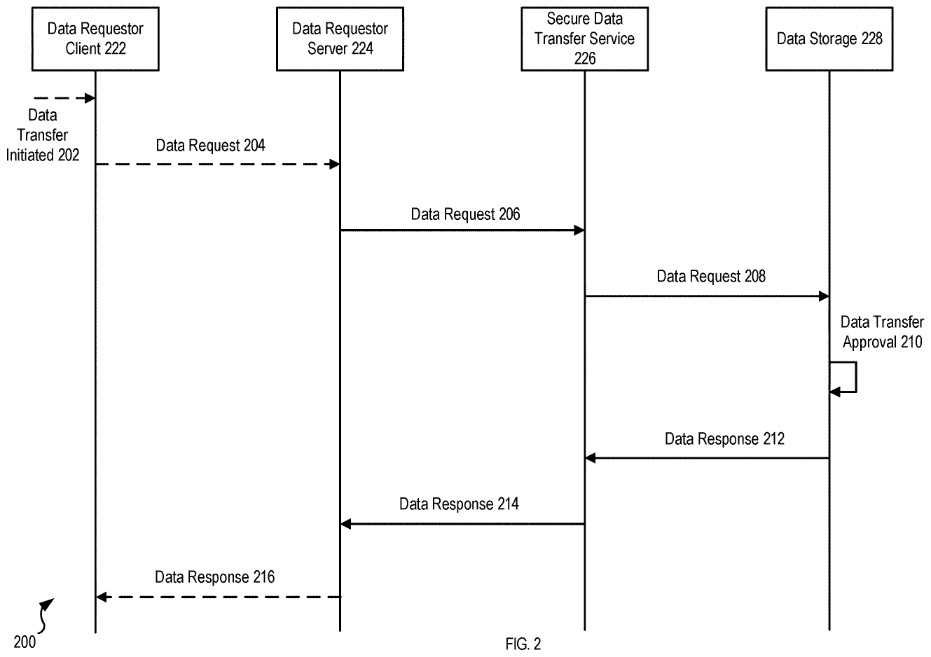

FIG. 2 illustrates a sequence diagram 200 of an example high-level sequence for implementing the techniques described herein. The sequence shown in sequence diagram 200 can optionally begin at block 202, where a data transfer of first data can be initiated at a data requestor client 222. For example, a user can initiate a data transfer at a data requestor client 222. In some examples, the data requestor client 222 can be a point-of-sale device. In some examples, the data requestor client 222 can be a data requestor client application on a user device.

When the sequence diagram 200 beings at block 202, a data request can be generated by the data requestor client 222. At block 204, the data requestor client 222 can transmit the data request to a data requestor server 224. The data request can include information identifying the data requested and a data storage 228 where the data is stored.

At block 206, the data requestor server 224 can transmit the data request to a secure data transfer service 226. The secure data transfer service 226 can perform various checks to verify the legitimacy of the data request, the data requestor client 222, and/or the data requestor server 224. The secure data transfer service 226 can approve the data request to be transmitted to the data storage 228. At block 208, the data request can be transmitted by the secure data transfer service 226 to the data storage 228.

At block 210, the data storage 228 can perform various checks to verify the legitimacy of the data request, the data requestor client 222, the data requestor server 224, and/or the secure data transfer service 226. The data request can include a first criteria for the first data. The data storage 228 can determine that the first data meets the first criteria and approve of the data transfer.

At block 212, the data storage 228 can generate a data response 212 including the first data. The data storage 228 can transmit the data response 212 to the secure data transfer service 226. The secure data transfer service 226 can perform various checks to verify the legitimacy of the data response, the data requestor server 224, and/or the data storage 228. At block 214, the secure data transfer service 226 can transmit the data response to the data requestor server 224.

In some examples, the sequence shown in sequence diagram 200 can include block 216. At block 216, the data requestor server 224 can transmit a data response to the data requestor client. In some examples, the data response at block 216 can be the same or similar to the data response at block 214. In some examples, the data response at block 216 may not include the first data, but rather include an indication that the data transfer was approved and/or completed.

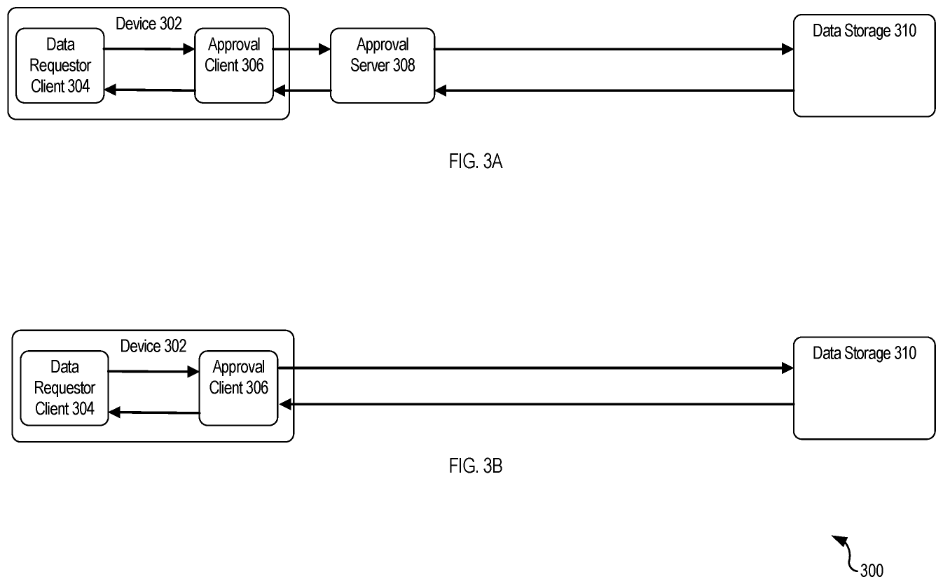

FIG. 3A illustrates an example block diagram for implementing the techniques described herein. In this example, a device 302 includes a data requestor client 304 and an approval client 306. The device 302 can be a user device or a point-of-sale device (for example, a point-of-sale terminal). The device 302 can transmit data transfer information to and receive data transfer information from an approval server 308 (for example, the data transfer approval request 102 of FIG. 1). The approval server 308 can transmit data transfer information to and receive data transfer information from the data storage 310. In relation to FIG. 1, the device 302 (including the data requestor client 304 and the approval client 306) and the approval server 308 can be an example implementation of the data requestor 122.

The data requestor client 304 can be an application. For example, the data requestor client 304 can be an application on a user device, such as a phone. The data requestor client 304 can receive an indication from a user for a data transfer. For example, a user may indicate that they want to perform a transaction and/or purchase in the data requestor client 304. In some examples, the data requestor client 304 can be a point-of-sale application to facilitate transactions for a merchant. For example, the point-of-sale application may be at a retail location of the merchant. In some examples, the data requestor client 304 can be an application that includes the ability for users to engage in microtransactions. For example, users may be able to perform in-app purchases and/or buy in-app currency. The data requestor client 304 can determine the first criteria regarding the first data for transmitting the first data. For example, the data requestor client 304 can determine that the first criteria is whether the user has sufficient funds to conduct the transaction.

In some examples, the data requestor client 304 can initiate a data transfer through an approval client 306. The approval client 306 can be an application on the device 302 that facilitates data transfers between a data requestor client 304 and a data storage 310. The approval client 306 can store data transfer information. For example, the approval client 306 can be a wallet application on a user device. In this example, the approval client 306 can include payment and/or transaction information, such as credit card or debit card information. An approval client 306 can provide data transfer information and/or communicate the data transfer information to an approval server 308. In some examples, the approval client 306 may not have sufficient information to directly communicate with the data storage 310 for security and/or privacy reasons. Instead, the approval client 306 may include a data storage identifier which can be sent to the approval server 308 with the data transfer information. The approval server 308 can determine which data storage 310 corresponds to the data storage identifier from the approval client 306.

In some examples, the approval client 306 can receive the first criteria the first criteria regarding the first data for transmitting the first data from the data requestor client 304. In some examples, the approval client 306 can generate a data transfer approval request including the first criteria. The approval client 306 can transmit the data transfer approval request to the approval server 308. The approval server 308 can then transmit the data transfer approval request to the data storage 310. In some examples, the approval client 306 can transmit the first criteria to the approval server 308 and the approval server 308 can generate the data transfer approval request including the first criteria.

The data storage 310 can determine whether the first criteria is met or not. The data storage 310 can transmit the data transfer approval response to the approval server 308 including an indication whether the first criteria is met or not. In some examples, the approval server 308 can transmit the data transfer approval response to the approval client 306. In some examples, an indication whether the first criteria is met or not can be transmitted by the approval client 306 to the data requestor client 304.

In some examples, the approval server 308 can transmit the data request to the secure data transfer service. In some examples, the approval client 306 can transmit the data request to the secure data transfer service. In some examples, the data requestor client 304 can transmit the data request to the secure data transfer service.

FIG. 3B illustrates an example block diagram for implementing the techniques described herein. In this example, there is a device 302 with a data requestor client 304 and an approval client 306 as described in relation to FIG. 3A. However, in this example, there is no approval server 308. Here, the approval client 306 has sufficient information to transmit the data transfer approval request to the data storage 310. For example, the approval client 306 has more information than a data storage identifier (for example, an address for the data storage 310) and is able to transmit the data transfer approval request directly to the data storage 310. Likewise, the data storage 310 can transmit the data transfer approval response directly back to the approval client 306 without any intervening approval server 308. In relation to FIG. 1, the device 302 (including the data requestor client 304 and the approval client 306) can be an example implementation of the data requestor 122.

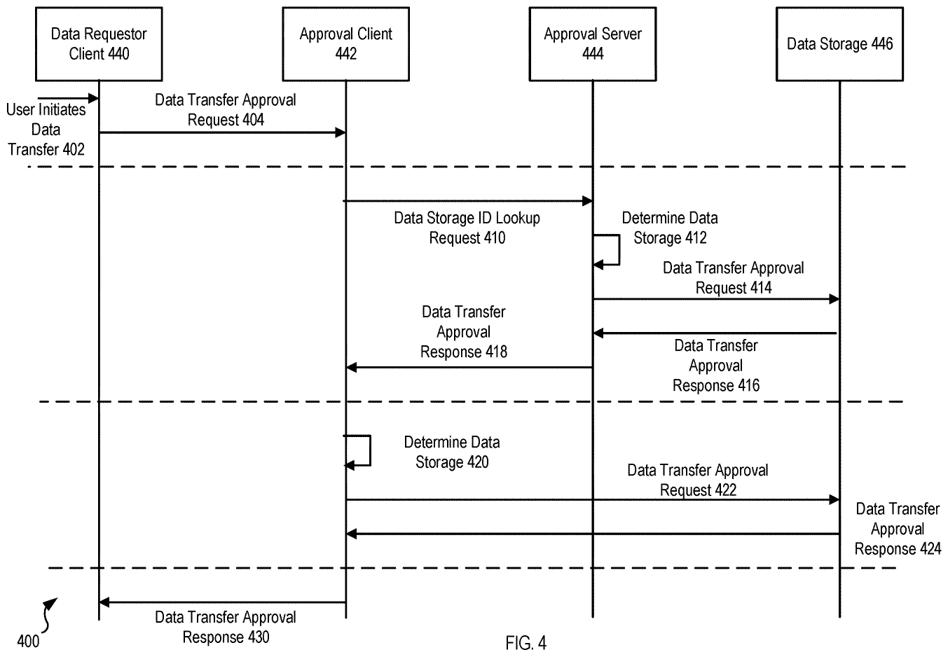

FIG. 4 illustrates a sequence diagram 400 of an example high-level sequence for implementing the techniques described herein. The sequence shown in sequence diagram 400 can begin with the initiation of a data transfer of first data at a data requestor client 440. For example, a user can initiate a data transfer at a data requestor client 440. In some examples, the data requestor client 440 can be a point-of-sale device. In some examples, the data requestor client 440 can be a data requestor client application on a user device.

At block 404, the data requestor client 440 can generate a data transfer approval request to send to the approval client 442. In some examples, the data requestor client 440 can determine a first criteria regarding the first data for transmitting the first data and generate the data transfer approval request based on the first criteria. In some examples, the data requestor client 440 can transmit the first criteria regarding the first data for transmitting the first data to the approval client 442. The approval client 442 can then generate the data transfer approval request based on the first criteria.

In some examples, the sequence shown in sequence diagram 400 can include blocks 410, 412, 414, 416, 418. In some examples, the sequence shown in sequence diagram 400 can alternatively include blocks 420, 422, 424 instead of blocks 410, 412, 414, 416, 418. Either set of blocks can be included with blocks 402, 404, 430.

At block 410, the approval client 442 can transmit the data transfer approval request and a data storage identifier lookup request to the approval server 444. In this example, the approval client 442 does not have sufficient information to transmit the data transfer approval request directly to the data storage 446. At block 412, the approval server 444 can determine a particular data storage for the data transfer of the first data based on the data storage identifier. At block 414, the approval server 444 can transmit the data transfer approval request to the data storage 416. The data storage 416 can determine if the first criteria regarding the first data for transmitting the first data has been met or not. The data storage 416 can generate a data transfer approval response based on that determination.

At block 416, the data storage 446 can transmit the data transfer approval response to the approval server 444 including an indication of whether the first criteria regarding the first data for transmitting the first data has been met or not. At block 418, the approval server 444 can transmit at least a portion of the data transfer approval response to the approval client 442. For example, the approval server 444 can transmit the entire data transfer approval response, a portion thereof, or only the indication of whether the first criteria regarding the first data for transmitting the first data has been met or not.

At block 420, the approval client 442 determines the data storage 446 associated with the data transfer approval request. At block 422, the approval client 442 transmits the data transfer approval request to the data storage 446. At block 424, the data storage 416 can determine if the first criteria regarding the first data for transmitting the first data has been met or not. The data storage 416 can generate a data transfer approval response based on that determination. The data storage 416 can then transmit the data transfer approval response to the approval client 442.

At block 430, the approval client 442 can transmit the data transfer approval response to the data requestor client 440 including an indication of whether the first criteria regarding the first data for transmitting the first data has been met or not. The approval client 442 can transmit at least a portion of the data transfer approval response to the data requestor client 440. For example, the approval client 442 can transmit the entire data transfer approval response, a portion thereof, or only the indication of whether the first criteria regarding the first data for transmitting the first data has been met or not.

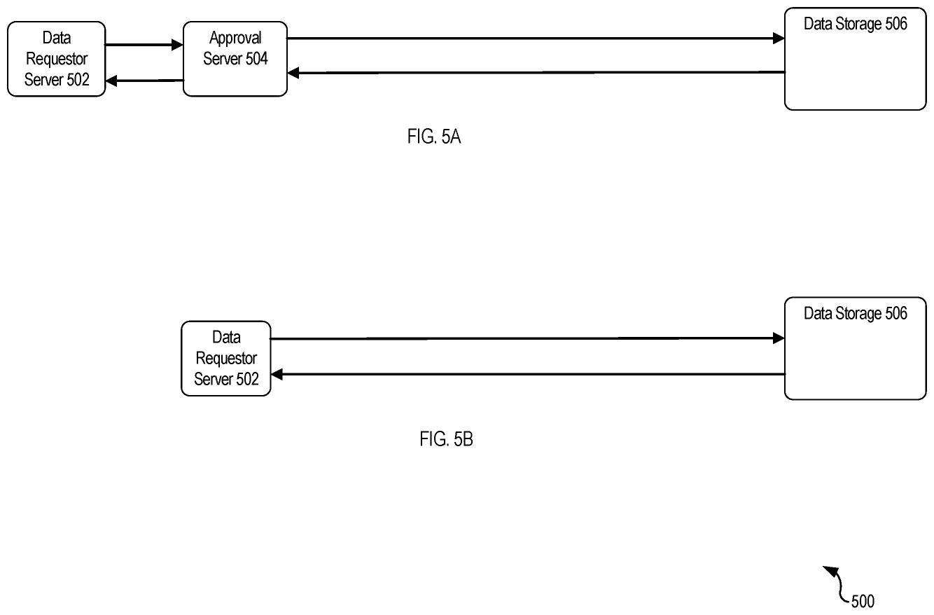

FIG. 5A illustrates an example block diagram for implementing the techniques described herein. In this example, the data requestor server 502 can transmit data transfer information to and receive data transfer information from an approval server 504. The approval server 504 can transmit data transfer information to and receive data transfer information from the data storage 506. In relation to FIG. 1, the data requestor server 502 and the approval server 504 can be an example implementation of the data requestor 122.

The data requestor server 502 can have data regarding periodic data transfers between the data storage 506 and the data requestor via the secure data transfer service. In this example, the data requestor server 502 can initiate a data transfer without a present indication for data transfer from a user. For example, a user may have a subscription to a service of the data requestor that results in periodic data transfers (for example, periodic transactions) between the data storage 506 and the data requestor. In such examples, a user does not need to interact with a user device in order to request a data transfer and transmit the data transfer approval request.

The data requestor server 502 can determine the first criteria regarding the first data for transmitting the first data. For example, the data requestor server 502 can determine that the first criteria is whether the user has sufficient funds to conduct a transaction. In this example, the data requestor server 502 can include payment and/or transaction information, such as credit card or debit card information. In some examples, the data requestor server 502 may not have sufficient information to directly communicate with the data storage 506 for security and/or privacy reasons. Instead, the data requestor server 502 may include a data storage identifier which can be sent to the approval server 504 with the data transfer information. The approval server 504 can determine which data storage 506 corresponds to the data storage identifier from the data requestor server 502.

In some examples, the approval server 504 can receive the first criteria the first criteria regarding the first data for transmitting the first data from the data requestor server 502. In some examples, the approval server 504 can generate a data transfer approval request including the first criteria. The approval server 504 can then transmit the data transfer approval request to the data storage 506. In some examples, the data requestor server 502 can determine the first criteria and can generate the data transfer approval request including the first criteria.

The data storage 506 can determine whether the first criteria is met or not. The data storage 506 can transmit the data transfer approval response to the approval server 504 including an indication whether the first criteria is met or not. In some examples, the approval server 504 can transmit the data transfer approval response to the data requestor server 502. In some examples, an indication whether the first criteria is met or not can be transmitted by the approval server 504 to the data requestor server 502.

In some examples, the approval server 504 can transmit the data request to the secure data transfer service. In some examples, the data requestor server 502 can transmit the data request to the secure data transfer service.

FIG. 5B illustrates an example block diagram for implementing the techniques described herein. In this example, there is a data requestor server 502 as described in relation to FIG. 5A. However, in this example, there is no approval server 504. Here, the data requestor server 502 has sufficient information to transmit the data transfer approval request to the data storage 506. For example, the data requestor server 502 has more information than a data storage identifier (for example, the address of the data storage 506) and is able to transmit the data transfer approval request directly to the data storage 506. Likewise, the data storage 506 can transmit the data transfer approval response directly back to the data requestor server 502 without any intervening approval server 504.

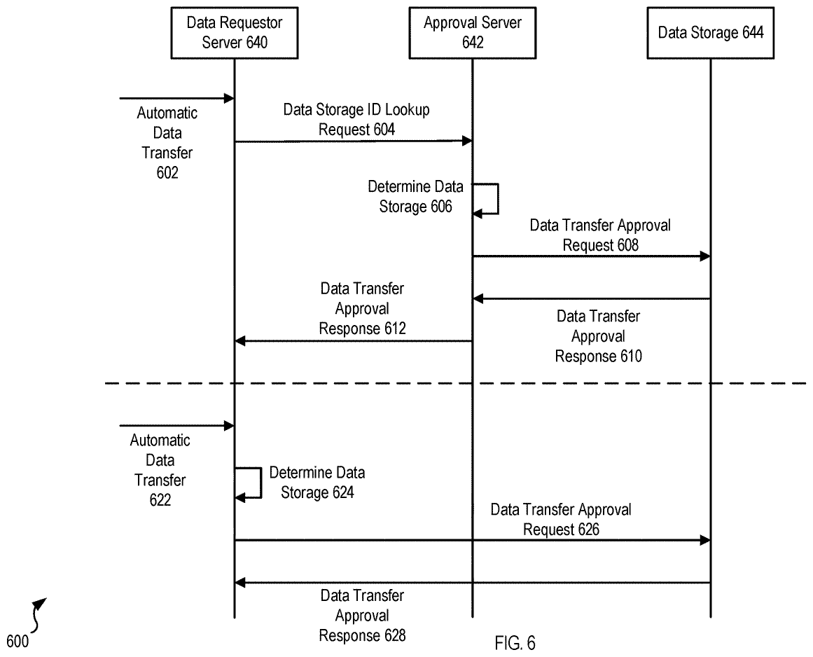

FIG. 6 illustrates a sequence diagram 600 of example high-level sequences for implementing the techniques described herein. A first sequence shown in sequence diagram 600 can begin at block 602 with an automatic data transfer at a data requestor server 640. For example, a periodic data transfer or a prescheduled data transfer can be performed at the data requestor server 640 without direct present user interaction.

At block 604, the data requestor server 640 can generate a data transfer approval request to send to the approval server 642. In some examples, the data requestor server 640 can determine a first criteria regarding the first data for transmitting the first data and generate the data transfer approval request based on the first criteria. In some examples, the data requestor server 640 can transmit the first criteria regarding the first data for transmitting the first data to the approval server 642. The approval server 642 can then generate the data transfer approval request based on the first criteria. The data requestor server 640 can also transmit a data storage identifier lookup request to the approval server 642. In this example, the data requestor server 640 does not have sufficient information to transmit the data transfer approval request directly to the data storage 644.

At block 606, the approval server 642 can determine a particular data storage for the data transfer of the first data based on the data storage identifier. At block 608, the approval server 642 can transmit the data transfer approval request to the data storage 644. The data storage 644 can determine if the first criteria regarding the first data for transmitting the first data has been met or not. The data storage 644 can generate a data transfer approval response based on that determination.

At block 610, the data storage 644 can transmit the data transfer approval response to the approval server 642 including an indication of whether the first criteria regarding the first data for transmitting the first data has been met or not. At block 612, the approval server 642 can transmit at least a portion of the data transfer approval response to the data requestor server 640. For example, the approval server 642 can transmit the entire data transfer approval response, a portion thereof, or only the indication of whether the first criteria regarding the first data for transmitting the first data has been met or not.

A second sequence shown in sequence diagram 600 can begin at block 622 with an automatic data transfer at a data requestor server 640. For example, a periodic data transfer or a prescheduled data transfer can be performed at the data requestor server 640 without direct present user interaction. At block 624, the data requestor server 640 determines the data storage 644 associated with the data transfer approval request. At block 626, the data requestor server 640 transmits the data transfer approval request to the data storage 644. At block 628, the data storage 644 can determine if the first criteria regarding the first data for transmitting the first data has been met or not. The data storage 644 can generate a data transfer approval response based on that determination. The data storage 644 can then transmit the data transfer approval response to the data requestor server 640.

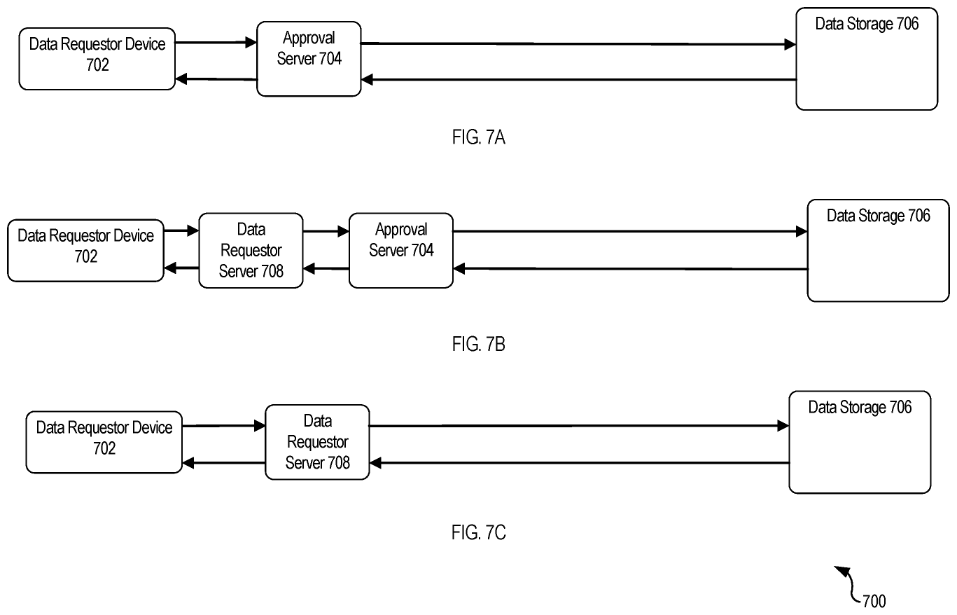

FIG. 7A illustrates an example block diagram for implementing the techniques described herein. In this example, the data requestor device 702 can transmit data transfer information to and receive data transfer information from an approval server 704. The data requestor device 702 can be a point-of-sale device (for example, a point-of-sale terminal). In some examples, the data requestor device 702 can be a point-of-sale device to facilitate transactions for a merchant. For example, the data requestor device 702 may be a point-of-sale device at a retail location of the merchant. The data requestor device 702 can transmit data transfer information to and receive data transfer information from an approval server 704. The approval server 704 can transmit data transfer information to and receive data transfer information from the data storage 706. In relation to FIG. 1, the data requestor device 702 and the approval server 704 can be an example implementation of the data requestor 122.

The data requestor device 702 can determine the first criteria regarding the first data for transmitting the first data. For example, the data requestor device 702 can determine that the first criteria is whether the user has sufficient funds to conduct a transaction. In this example, the data requestor device 702 can receive payment and/or transaction information, such as from a credit card or debit card. In some examples, the data requestor device 702 may not have sufficient information to directly communicate with the data storage 706 for security and/or privacy reasons. Instead, the data requestor device 702 may receive a data storage identifier which can be sent to the approval server 704 with the data transfer information. For example, the data requestor device 702 can receive a data storage identifier from an instrument such as a credit card or debit card. The approval server 704 can determine which data storage 706 corresponds to the data storage identifier from the data requestor device 702.

In some examples, the approval server 704 can receive the first criteria the first criteria regarding the first data for transmitting the first data from the data requestor server 502. In some examples, the approval server 704 can generate a data transfer approval request including the first criteria. The approval server 704 can then transmit the data transfer approval request to the data storage 706. In some examples, the data requestor device 702 can determine the first criteria and can generate the data transfer approval request including the first criteria.

The data storage 706 can determine whether the first criteria is met or not. The data storage 706 can transmit the data transfer approval response to the approval server 704 including an indication whether the first criteria is met or not. In some examples, the approval server 704 can transmit the data transfer approval response to the data requestor device 702. In some examples, an indication whether the first criteria is met or not can be transmitted by the approval server 704 to the data requestor device 702.

In some examples, the approval server 704 can transmit the data request to the secure data transfer service. In some examples, the data requestor device 702 can transmit the data request to the secure data transfer service.

FIG. 7B illustrates an example block diagram for implementing the techniques described herein. In this example, there is a data requestor device 702 as described in relation to FIG. 7A. However, in this example, there is also a data requestor server 708. Here, the data requestor device 702 transmits the data transfer approval request and/or the first criteria to the data requestor server 708. The data requestor server 708 then transmits the data transfer approval request and/or the first criteria to the approval server 704. Here, the data requestor server 708 may not have sufficient information to transmit the data transfer approval request to the data storage 706. For example, the data requestor server 708 may have a data storage identifier, but no additional information (for example, the address of the data storage 706). The data requestor server 708 can transmit the data transfer approval request to the approval server 704. The approval server 704 can determine the particular data storage 706 from the data storage identifier. Likewise, the data storage 706 can transmit the data transfer approval response back to the approval server 704, and the approval server 704 can transmit the data transfer approval response back to the data requestor server 708.

FIG. 7C illustrates an example block diagram for implementing the techniques described herein. In this example, there is a data requestor device 702 and a data requestor server 708 as described in relation to FIG. 7B. However, in this example, there is no approval server 704. Here, the data requestor server 708 has sufficient information to transmit the data transfer approval request to the data storage 706. For example, the data requestor server 708 has more information than a data storage identifier (for example, the address of the data storage 706) and is able to transmit the data transfer approval request directly to the data storage 706. Likewise, the data storage 706 can transmit the data transfer approval response directly back to the data requestor server 708 without any intervening approval server 704.

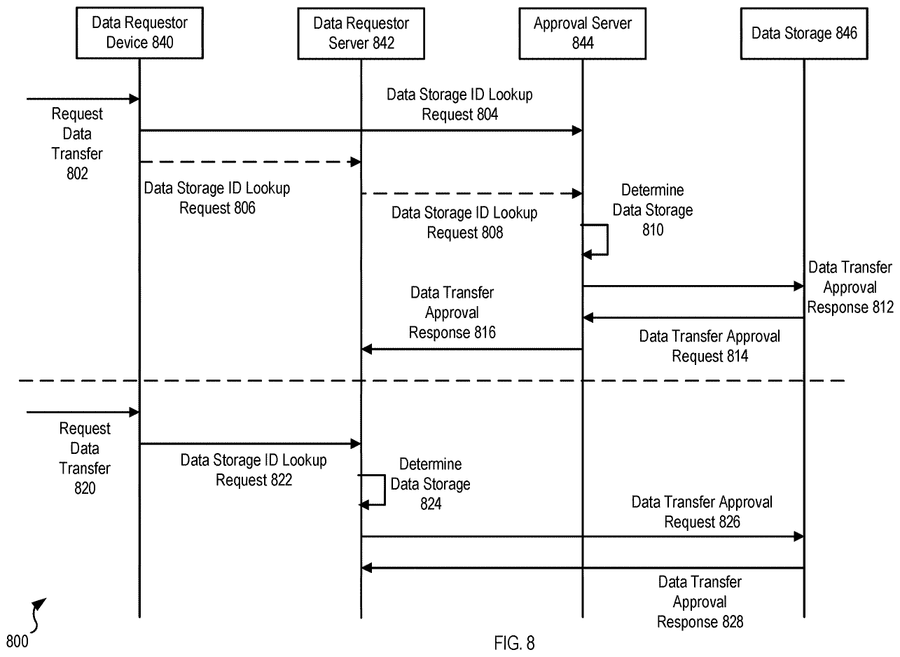

FIG. 8 illustrates a sequence diagram 800 of example high-level sequences for implementing the techniques described herein. A first sequence shown in sequence diagram 800 can begin at block 802 with the data requestor device 840 receiving a request for a data transfer.

At block 804, the data requestor device 840 can generate a data transfer approval request to send to the approval server 844. In some examples, the data requestor device 840 can determine a first criteria regarding the first data for transmitting the first data and generate the data transfer approval request based on the first criteria. In some examples, the data requestor device 840 can transmit the first criteria regarding the first data for transmitting the first data to the approval server 844. The approval server 844 can then generate the data transfer approval request based on the first criteria. The data requestor device 840 can also transmit a data storage identifier lookup request to the approval server 844. In this example, the data requestor device 840 does not have sufficient information to transmit the data transfer approval request directly to the data storage 846.

Alternatively to block 804, at block 806, the data requestor device 840 can generate a data transfer approval request to send to the data requestor server 842. In some examples, the data requestor device 840 can determine a first criteria regarding the first data for transmitting the first data and generate the data transfer approval request based on the first criteria. In some examples, the data requestor device 840 can transmit the first criteria regarding the first data for transmitting the first data to the requestor server 842. The data requestor server 842 can then generate the data transfer approval request based on the first criteria. The data requestor device 840 can also transmit a data storage identifier lookup request to the requestor server 842. In this example, the data requestor device 840 does not have sufficient information to transmit the data transfer approval request directly to the data storage 846.

Likewise, at block 808, the data requestor server 842 can generate a data transfer approval request to send to the approval server 844. In some examples, the data requestor server 842 can determine a first criteria regarding the first data for transmitting the first data and generate the data transfer approval request based on the first criteria. In some examples, data requestor server 842 can transmit the first criteria regarding the first data for transmitting the first data to the approval server 844. The approval server 844 can then generate the data transfer approval request based on the first criteria. The data requestor server 842 can also transmit a data storage identifier lookup request to the approval server 844. In this example, the data requestor server 842 does not have sufficient information to transmit the data transfer approval request directly to the data storage 846.

After block 804 or 808, at block 810, the approval server 844 can determine a particular data storage for the data transfer of the first data based on the data storage identifier. At block 812, the approval server 844 can transmit the data transfer approval request to the data storage 846. The data storage 846 can determine if the first criteria regarding the first data for transmitting the first data has been met or not. The data storage 846 can generate a data transfer approval response based on that determination.

At block 814, the data storage 846 can transmit the data transfer approval response to the approval server 844 including an indication of whether the first criteria regarding the first data for transmitting the first data has been met or not. At block 816, the approval server 844 can transmit at least a portion of the data transfer approval response to the data requestor server 842. For example, the approval server 844 can transmit the entire data transfer approval response, a portion thereof, or only the indication of whether the first criteria regarding the first data for transmitting the first data has been met or not.

A second sequence shown in sequence diagram 800 can begin at block 802 with the data requestor device 840 receiving a request for a data transfer. At block 822, the data requestor device 840 can generate a data transfer approval request to send to the data requestor server 842. In some examples, the data requestor device 840 can determine a first criteria regarding the first data for transmitting the first data and generate the data transfer approval request based on the first criteria. In some examples, the data requestor device 840 can transmit the first criteria regarding the first data for transmitting the first data to the data requestor server 842. The data requestor server 842 can then generate the data transfer approval request based on the first criteria. The data requestor device 840 can also transmit a data storage identifier lookup request to the data requestor server 842. In this example, the data requestor device 840 does not have sufficient information to transmit the data transfer approval request directly to the data storage 846.

At block 824, the data requestor server 842 can determine a particular data storage for the data transfer of the first data based on the data storage identifier. At block 826, the data requestor server 842 can transmit the data transfer approval request to the data storage 846. The data storage 846 can determine if the first criteria regarding the first data for transmitting the first data has been met or not. The data storage 846 can generate a data transfer approval response based on that determination. At block 828, the data storage 846 can transmit the data transfer approval response to the data requestor server 842 including an indication of whether the first criteria regarding the first data for transmitting the first data has been met or not.

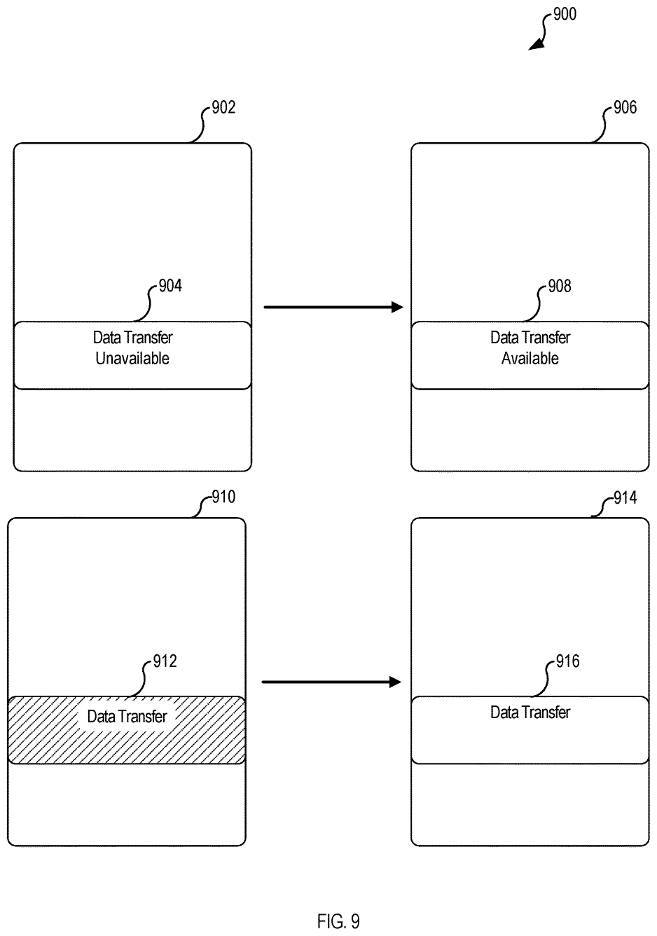

FIG. 9 illustrates example user interface elements for implementing the techniques described herein. User interface 902 includes a user interface element 904 on a device where the data transfer is shown to be unavailable by being labeled unavailable. The data transfer may be unavailable for a variety of reasons. For example, the data transfer may be unavailable because data transfer approval request and response process has not been completed. Similarly, the data transfer may be unavailable because data transfer approval request indicated that the first criteria related to the first data was not met. The data transfer cannot be activated via the user interface while user interface element 904 is showing. If the device has received a data transfer approval response indicating that the first criteria related to the first data has been met, the user interface 902 can change to user interface 906 with user interface element 908 indicating that the data transfer is available. The user can then interact with user interface element 908 to initiate a data transfer.

Similarly, user interface 910 includes a user interface element 912 on a device where the data transfer is shown to be unavailable by being grayed out. The data transfer cannot be activated via the user interface while user interface element 912 is showing. If the device has received a data transfer approval response indicating that the first criteria related to the first data has been met, the user interface 902 can change to user interface 914 with user interface element 916. The data transfer is available as indicated by the user interface element 916 not being grayed out. The user can then interact with user interface element 916 to initiate a data transfer.

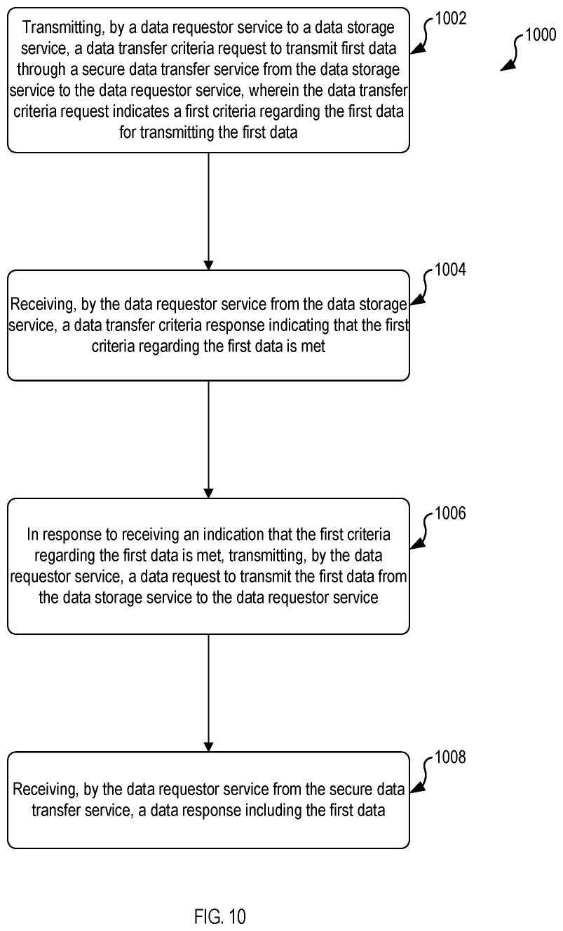

FIG. 10 illustrates an example process 1000 for determining that data meets criteria prior to transferring the data through a secure data transfer service from a data storage to a data requestor. Process 1000 is illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

At block 1002, a data requestor service can transmit, to a data storage service, a data transfer criteria request to transmit first data through a secure data transfer service from the data storage service to the data requestor service. The data transfer criteria request can indicate a first criteria regarding the first data for transmitting the first data. The data requestor service can transmit the data request to the data storage service. The data requestor service can transmit the data request to the secure data transfer service.

At block 1004, the data requestor service can receive, from the data storage service, a data transfer criteria response indicating that the first criteria regarding the first data is met.

At block 1006, in response to receiving an indication that the first criteria regarding the first data is met, the data requestor service can transmit a data request to transmit the first data from the data storage service to the data requestor service. At block 1008, the data requestor service can receive, from the secure data transfer service, a data response including the first data.

The process 1000 can further include receiving, by the data requestor service from a user device, a data transfer request to transmit the first data from the data storage service to the data requestor service through the secure data transfer service, wherein the data transfer request includes the first criteria and a data storage identifier. The process can further include determining, by the data requestor service, the data storage service based at least in part on the data storage identifier. The process 1000 can further include transmitting, by the data requestor service to the user device, data transfer approval information configured to cause the user device to display an indication that the first criteria regarding the first data is met. The user device can be a point of sale device.

The process 1000 can further include receiving, by the data requestor service from a requesting device, a data transfer request to transmit the first data from the data storage service to the data requestor service through the secure data transfer service, wherein the data transfer request includes the first criteria and a data storage identifier. The process 1000 can further include determining, by the data requestor service, the data storage service based at least in part on the data storage identifier. The process 100 can further include transmitting, by the data requestor service to the requesting device, data transfer approval information configured to cause the requesting device to transmit, by the requesting device to the requestor service, the data request. The process 1000 can further include transmitting, by the data requestor service, to the requesting device, the data response including the first data. The data transfer request can be part of a periodic set of data transfer requests.

The process 1000 can further include, in response to receiving an indication that the first criteria regarding the first data is not met, transmitting, by the data requestor service to a user device, data transfer non-approval information configured to cause the user device to display an indication that the first criteria regarding the first data is not met.

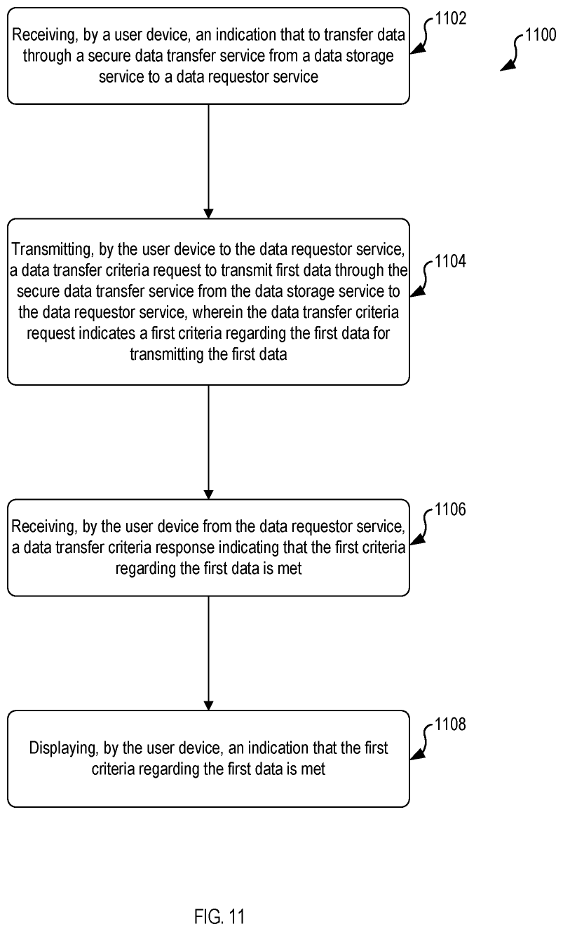

FIG. 11 illustrates an example process 1100 for determining that data meets criteria prior to transferring the data through a secure data transfer service from a data storage to a data requestor. Process 1100 is illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

At block 1102, a user device can receive an indication that to transfer data through a secure data transfer service from a data storage service to a data requestor service.

At block 1104, the user device can transmit, to the data requestor service, a data transfer criteria request to transmit first data through the secure data transfer service from the data storage service to the data requestor service. The data transfer criteria request indicates a first criteria regarding the first data for transmitting the first data.

In some examples, at block 1104, the user device can transmit, to the data storage service, a data transfer criteria request to transmit first data through the secure data transfer service from the data storage service to the data requestor service. The data transfer criteria request indicates a first criteria regarding the first data for transmitting the first data.

At block 1106, the user device can receive, from the data requestor service, a data transfer criteria response indicating that the first criteria regarding the first data is met. In some examples, at block 1106, the user device can receive, from the data storage service, a data transfer criteria response indicating that the first criteria regarding the first data is met. At block 1108, the user device can display, an indication that the first criteria regarding the first data is met.

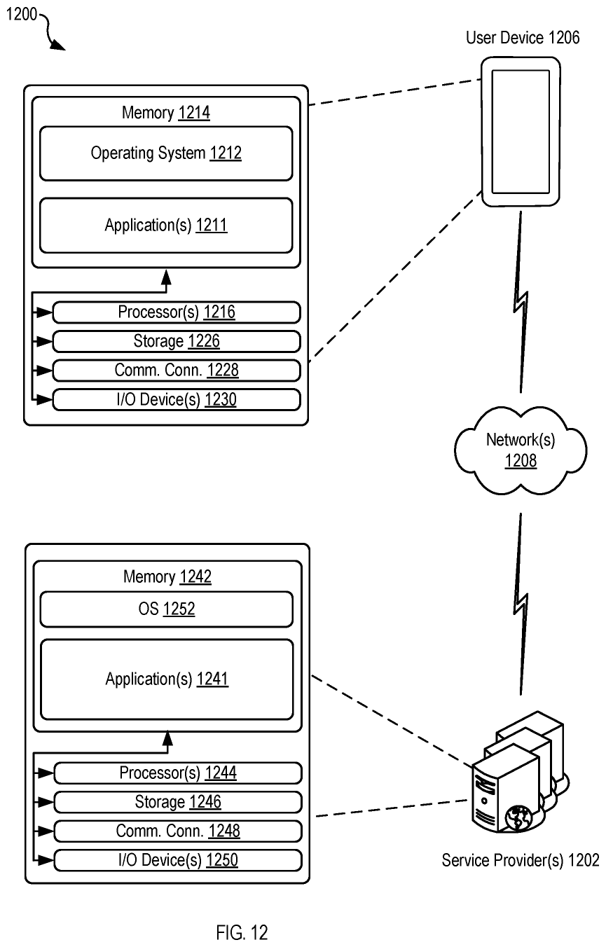

FIG. 12 illustrates an example architecture or environment 1200 configured to implement techniques described herein, according to at least one example. In some examples, the example architecture 1200 may further be configured to enable a user device 1206 and service provider computer 1202 to share information. The service provider computer 1202 is an example of data requestor 122, data storage 124, and secure data transfer 126. The user device 1106 is an example of the user device 302 and data requestor device 702. In some examples, the devices may be connected via one or more networks 1208 (e.g., via Bluetooth, WiFi, the Internet). In some examples, the service provider computer 1202 may be configured to implement at least some of the techniques described herein with reference to the user device 1206 and vice versa.

In some examples, the networks 1208 may include any one or a combination of many different types of networks, such as cable networks, the Internet, wireless networks, cellular networks, satellite networks, other private and/or public networks, or any combination thereof. While the illustrated example represents the user device 1206 accessing the service provider computer 1202 via the networks 1208, the described techniques may equally apply in instances where the user device 1206 interacts with the service provider computer 1202 over a landline phone, via a kiosk, or in any other manner. It is also noted that the described techniques may apply in other client/server arrangements (e.g., set-top boxes), as well as in non-client/server arrangements (e.g., locally stored applications, peer-to-peer configurations).

As noted above, the user device 1206 may be any type of computing device such as, but not limited to, a mobile phone, a smartphone, a personal digital assistant (PDA), a laptop computer, a desktop computer, a thin-client device, a tablet computer, a wearable device such as a smart watch, or the like. In some examples, the user device 1206 may be in communication with the service provider computer 1202 via the network 1208, or via other network connections.

In one illustrative configuration, the user device 1206 may include at least one memory 1214 and one or more processing units (or processor(s)) 1216. The processor(s) 1216 may be implemented as appropriate in hardware, computer-executable instructions, firmware, or combinations thereof. Computer-executable instruction or firmware implementations of the processor(s) 1216 may include computer-executable or machine-executable instructions written in any suitable programming language to perform the various functions described. The user device 1206 may also include geo-location devices (e.g., a global positioning system (GPS) device or the like) for providing and/or recording geographic location information associated with the user device 1206.

The memory 1214 may store program instructions that are loadable and executable on the processor(s) 1216, as well as data generated during the execution of these programs. Depending on the configuration and type of the user device 1206, the memory 1214 may be volatile (such as random access memory (RAM)) and/or non-volatile (such as read-only memory (ROM), flash memory). The user device 1206 may also include additional removable storage and/or non-removable storage 1226 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 1214 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 1214 and the additional storage 1226, both removable and non-removable, are all examples of non-transitory computer-readable storage media. For example, non-transitory computer-readable storage media may include volatile or non-volatile, removable or non-removable media implemented in any method or technology for storage of information such as computer-readable instructions, data structures, program modules, or other data. The memory 1214 and the additional storage 1226 are both examples of non-transitory computer-storage media. Additional types of computer-storage media that may be present in the user device 1206 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 1206. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 1206 may also contain communications connection(s) 1228 that allow the user device 1206 to communicate with a data store, another computing device or server, user terminals, and/or other devices via the network 1208. The user device 1206 may also include I/O device(s) 1230, such as a keyboard, a mouse, a pen, a voice input device, a touch screen input device, a display, speakers, and a printer.

Turning to the contents of the memory 1214 in more detail, the memory 1214 may include an operating system 1213 and/or one or more application programs or services for implementing the features disclosed herein such as applications 1211 (e.g., data requestor client 304, approval client 306, digital wallet, third-party applications, browser application). In some examples, the applications 1211 may include applications to perform similar techniques as described with reference to the user device 1206. Applications 1211 can perform some or all the techniques described herein. Similarly, at least some techniques described with reference to the service provider computer 1202 may be performed by the user device 1206.

The service provider computer 1202 may also be any type of computing device such as, but not limited to, a collection of virtual or “cloud” computing resources, a remote server, a mobile phone, a smartphone, a PDA, a laptop computer, a desktop computer, a thin-client device, a tablet computer, a wearable device, a server computer, or a virtual machine instance. In some examples, the service provider computer 1202 may be in communication with the user device 1206 via the network 1208, or via other network connections.

In one illustrative configuration, the service provider computer 1202 may include at least one memory 1242 and one or more processing units (or processor(s)) 1244. The processor(s) 1244 may be implemented as appropriate in hardware, computer-executable instructions, firmware, or combinations thereof. Computer-executable instruction or firmware implementations of the processor(s) 1244 may include computer-executable or machine-executable instructions written in any suitable programming language to perform the various functions described.

The memory 1242 may store program instructions that are loadable and executable on the processor(s) 1244, as well as data generated during the execution of these programs. Depending on the configuration and type of service provider computer 1202, the memory 1242 may be volatile (such as RAM) and/or non-volatile (such as ROM and flash memory). The service provider computer 1202 may also include additional removable storage and/or non-removable storage 1246 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 1242 may include multiple different types of memory, such as SRAM, DRAM, or ROM. While the volatile memory described herein may be referred to as RAM, any volatile memory that would not maintain data stored therein, once unplugged from a host and/or power, would be appropriate. The memory 1242 and the additional storage 1246, both removable and non-removable, are both additional examples of non-transitory computer-readable storage media.

The service provider computer 1202 may also contain communications connection(s) 1248 that allow the service provider computer 1202 to communicate with a data store, another computing device or server, user terminals, and/or other devices via the network 1208. The service provider computer 1202 may also include I/O device(s) 1250, such as a keyboard, a mouse, a pen, a voice input device, a touch input device, a display, speakers, and a printer.

Turning to the contents of the memory 1242 in more detail, the memory 1242 may include an operating system 1252 and/or one or more application programs 1241 or services for implementing the features disclosed herein. For example, the services and applications associated with or corresponding to the data requestor 122, data storage 124, secure data transfer service 126, approval server 308, and data requestor server 502 correspond to applications 1141 on the service providers 1102, such that the data requestor 122, data storage 124, secure data transfer service 126, approval server 308, and data requestor server 502 may include other applications for other features and/or services. Applications 1241 can perform some or all of the techniques as described herein.

The various examples can be further implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, keypad), and at least one output device (e.g., a display device, printer, speaker). Such a system may also include one or more storage devices, such as disk drives, optical storage devices, and solid-state storage devices such as RAM or ROM, as well as removable media devices, memory cards, flash cards, etc.

Such devices can also include a computer-readable storage media reader, a communications device (e.g., a modem, a network card (wireless or wired), an infrared communication device), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets), or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

As described above, one aspect of the present technology is the gathering and use of data available from various sources to provide a comprehensive and complete window to a user's personal health record. The present disclosure contemplates that in some instances, this gathered data may include personally identifiable information (PII) data that uniquely identifies or can be used to contact or locate a specific person. Such personal information data can include demographic data, location-based data, telephone numbers, email addresses, Twitter IDs, home addresses, data or records relating to a user's health or level of fitness (e.g., vital sign measurements, medication information, exercise information), date of birth, health record data, or any other identifying or personal or health information.

The present disclosure recognizes that the use of such personal information data, in the present technology, can be used to the benefit of users. For example, the personal information data can be used to provide enhancements to a user's personal health record. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the U.S., collection of or access to certain health data may be governed by federal and/or state laws, such as the Health Insurance Portability and Accountability Act (HIPAA); whereas health data in other countries may be subject to other regulations and policies and should be handled accordingly. Hence, different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services or other services relating to health record management, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A method, comprising:
transmitting, by a data requestor service to a data storage service, a data transfer criteria request to transmit first data through a secure data transfer service from the data storage service to the data requestor service, wherein the data transfer criteria request indicates a first criteria regarding the first data for transmitting the first data;
receiving, by the data requestor service from the data storage service, a data transfer criteria response indicating that the first criteria regarding the first data is met;
in response to receiving an indication that the first criteria regarding the first data is met, transmitting, by the data requestor service, a data request to transmit the first data from the data storage service to the data requestor service; and
receiving, by the data requestor service from the secure data transfer service, a data response including the first data.

2. The method of claim 1, further comprising:
receiving, by the data requestor service from a user device, a data transfer request to transmit the first data from the data storage service to the data requestor service through the secure data transfer service, wherein the data transfer request includes the first criteria and a data storage identifier; and
determining, by the data requestor service, the data storage service based at least in part on the data storage identifier.

3. The method of claim 2, further comprising transmitting, by the data requestor service to the user device, data transfer approval information configured to cause the user device to display an indication that the first criteria regarding the first data is met.

4. The method of claim 2, wherein the user device is a point of sale device.

5. The method of claim 1, further comprising:
receiving, by the data requestor service from a requesting device, a data transfer request to transmit the first data from the data storage service to the data requestor service through the secure data transfer service, wherein the data transfer request includes the first criteria and a data storage identifier; and
determining, by the data requestor service, the data storage service based at least in part on the data storage identifier.

6. The method of claim 5, further comprising transmitting, by the data requestor service to the requesting device, data transfer approval information configured to cause the requesting device to transmit, by the requesting device to the requestor service, the data request.

7. The method of claim 5, further comprising transmitting, by the data requestor service, to the requesting device, the data response including the first data.

8. The method of claim 5, wherein the data transfer request is part of a periodic set of data transfer requests.

9. The method of claim 1, further comprising:
in response to receiving an indication that the first criteria regarding the first data is not met, transmitting, by the data requestor service to a user device, data transfer non-approval information configured to cause the user device to display an indication that the first criteria regarding the first data is not met.

10. The method of claim 1, wherein the data requestor service transmits the data request to the data storage service.

11. The method of claim 1, wherein the data requestor service transmits the data request to the secure data transfer service.

12. A system, comprising:
one or more memories; and
one or more processors in communication with the one or more memories and configured to execute instructions stored in the one or more memories to cause the system to:
transmit, to a data storage service, a data transfer criteria request to transmit first data through a secure data transfer service from the data storage service to the system, wherein the data transfer criteria request indicates a first criteria regarding the first data for transmitting the first data;
receive, from the data storage service, a data transfer criteria response indicating that the first criteria regarding the first data is met;
in response to receiving an indication that the first criteria regarding the first data is met, transmit a data request to transmit the first data from the data storage service to the system; and
receive, from the secure data transfer service, a data response including the first data.

13. The system of claim 12, wherein the one or more processors are further configured to:
receive, from a user device, a data transfer request to transmit the first data from the data storage service to the system through the secure data transfer service, wherein the data transfer request includes the first criteria and a data storage identifier; and
determine the data storage service based at least in part on the data storage identifier.

14. The system of claim 13, wherein the one or more processors are further configured to transmit, to the user device, data transfer approval information configured to cause the user device to display an indication that the first criteria regarding the first data is met.

15. The system of claim 12, wherein the system transmits the data request to the data storage service.

16. The system of claim 12, wherein the system transmits the data request to the secure data transfer service.

17. A non-transitory computer-readable storage medium having stored thereon program instructions that, when executed by one or more processors of a data requestor service, cause the data requestor service to perform operations comprising:
transmitting, a data storage service, a data transfer criteria request to transmit first data through a secure data transfer service from the data storage service to the data requestor service, wherein the data transfer criteria request indicates a first criteria regarding the first data for transmitting the first data;
receiving, from the data storage service, a data transfer criteria response indicating that the first criteria regarding the first data is met;
in response to receiving an indication that the first criteria regarding the first data is met, transmitting a data request to transmit the first data from the data storage service to the data requestor service; and
receiving, from the secure data transfer service, a data response including the first data.

18. The non-transitory computer-readable storage medium of claim 17, further comprising:
receiving, from a requesting device, a data transfer request to transmit the first data from the data storage service to the data requestor service through the secure data transfer service, wherein the data transfer request includes the first criteria and a data storage identifier; and
determining the data storage service based at least in part on the data storage identifier.

19. The non-transitory computer-readable storage medium of claim 18, further comprising transmitting, to the requesting device, data transfer approval information configured to cause the requesting device to transmit, by the requesting device to the requestor service, the data request.

20. The non-transitory computer-readable storage medium of claim 18, further comprising transmitting, to the requesting device, the data response including the first data.
